(19) United States
(12) Patent Application Publication
(10) Pub. No.: US 2026/0208338 A1
(43) Pub. Date: Jul. 23, 2026

(54) FIRING PIN TWO-STAGE LIFTING STRUCTURE FOR PNEUMATIC TOOL

(71) Applicant: Feng REN, Ningbo (CN)

(72) Inventor: Feng REN, Ningbo (CN)

(21) Appl. No.: 19/139,457

(22) PCT Filed: Dec. 2, 2024
(86) PCT No.: PCT/CN2024/136082

§ 371 Date: Jun. 16, 2025

(30) Foreign Application Priority Data
Oct. 11, 2023 (CN) 202322722329.6

(51) Int. Cl. B25C 1/04

(52) U.S. Cl. CPC B25C 1/047

(57) ABSTRACT

Disclosed is a firing pin two-stage lifting structure for a pneumatic tool, including a pneumatic tool body in which a firing pin and a driving mechanism for driving the firing pin to be lifted are disposed, where a tail end of the firing pin is fitted in an air storage chamber, and the driving mechanism includes a driving wheel connected to a driving device, the driving wheel having a first driving part engaged with a first engaging part via a transition member and second driving parts engaged with the second engaging part, and the first engaging part and the second engaging part being respectively provided on two sides of the firing pin correspondingly. As the driving wheel rotates, the first driving part and the second driving parts are sequentially engaged with the first engaging part and the second engaging part correspondingly. The firing pin two-stage lifting structure for a pneumatic tool has the following advantages: the structure is rational and compact, and with the design of the two-stage lifting structure, it increases the distance by which the firing pin is lifted, thereby increasing a striking force during firing of the firing pin.

### TECHNICAL FIELD

The present disclosure relates to the technical field of pneumatic tool manufacturing, and in particular to a firing pin two-stage lifting structure for a pneumatic tool.

### BACKGROUND ART

Pneumatic tools are tools that use air pressure as a power source, such as pneumatic nail guns. The pneumatic nail gun uses air pressure in an air reservoir to strike a firing pin, realizing nail firing by the striking of the firing pin on a nail.

The Patent Application No. CN202020898461.6 and entitled “PNEUMATIC NAIL GUN” discloses a pneumatic nail gun, which includes a shell, a motor, a first air cylinder, a second air cylinder, a nail feeding assembly, a trigger, a first piston, and a second piston. The motor drives a gear to drive a rack such that the first piston reciprocates in the first air cylinder, the second air cylinder is in the first air cylinder, the first air cylinder and the second air cylinder share a front end cap and a tail end cap, the second piston is provided with a counterweight block and a shock-absorbing ring, a latch assembly is mounted on an inner side of the tail end cap to lock the second piston, and the first piston is provided with a release ejector pin used for releasing the latch assembly. The firing pin is connected to the pistons. Under the same cylinder conditions, the greater the distance by which the firing pin is lifted, the greater the firing force that can be generated, and the stronger the penetration force of the nail gun after firing. Therefore, in order to improve the penetration force of the nail gun, the firing pin lifting structure of the pneumatic nail gun needs to be further improved.

### SUMMARY

An objective of the present disclosure is to disclose, to the society, a firing pin two-stage lifting structure for a pneumatic tool that is rational and compact and capable of increasing the distance by which a firing pin is lifted, in order to make up for deficiencies mentioned above.

The technical solution of the present disclosure is implemented as follows:
A firing pin two-stage lifting structure for a pneumatic tool includes a pneumatic tool body, a firing pin and a driving mechanism for driving the firing pin to be lifted are disposed in the pneumatic tool body, a tail end of the firing pin is fitted in an air storage chamber, the driving mechanism includes a driving wheel connected to a driving device, the driving wheel is provided with a first driving part and second driving parts, a first engaging part and a second engaging part are respectively provided on two sides of the firing pin correspondingly, the first driving part is engaged with the first engaging part via a transition member, and the second driving parts are engaged with the second engaging part; and as the driving wheel rotates, the first driving part and the second driving parts are sequentially engaged with the first engaging part and the second engaging part correspondingly.

Measures to further optimize the technical solution are as follows:
As an improvement, the first driving part is a driving block, the first engaging part is a bump disposed on one side of the firing pin, and the transition member is disposed across the firing pin. The driving block acts on the transition member and then the transition member acts on the bump of the firing pin, thereby completing a first-stage lifting.

As an improvement, the transition member is provided with an acting part that extends into a moving trajectory of the first driving part, and the transition member is further provided with an abutting part that is in abutting fit with the first engaging part. The acting part is engaged with the first driving part such that the transition member realizes force transmission. The abutting part acts on the first engaging part such that the force is transmitted to the firing pin.

As an improvement, the second driving parts are a plurality of driving posts spaced apart from each other, the driving posts are distributed in a circular arc, and the second engaging part is a rack disposed on the other side of the firing pin. The driving posts act one by one on corresponding teeth of the rack to complete a second-stage lifting.

As an improvement, a distance from the first driving part to a center of rotation of the driving wheel is greater than a distance from the second driving parts to the center of rotation of the driving wheel. Since the force needed for the second-stage lifting of the firing pin is greater than the force needed for the first-stage lifting, a rotation radius of the second driving parts is smaller than a rotation radius of the first driving part, enabling a better lifting of the firing pin.

As an improvement, the driving wheel is provided with an extension that extends outwards radially, and the first driving part is disposed on the extension.

As an improvement, a guide chute is provided in the pneumatic tool body, and the transition member is slidably disposed in the guide chute. The guide chute acts as a guide, allowing the transition member to slide more smoothly.

As an improvement, the driving device is a motor.

Compared with the prior art, the present disclosure has the following advantages:
The firing pin two-stage lifting structure for a pneumatic tool according to the present disclosure has a rational structure. Since the first engaging part and the second engaging part are respectively provided on two sides of the firing pin correspondingly, and the first driving part and the second driving parts are correspondingly provided on the driving wheel, the structure is compact. As the driving wheel rotates, the first driving part acts on the first engaging part to realize a first-stage lifting, and then the second driving parts act on the second engaging part to realize a second-stage lifting. With the design of the two-stage lifting structure, it increases the distance by which the firing pin is lifted, thereby increasing a striking force during firing of the firing pin.

### BRIEF DESCRIPTION OF THE DRAWINGS

FIG. 1 is a perspective structural diagram of an embodiment of the present disclosure;

FIG. 2 is an enlarged view of part A in FIG. 1;

FIG. 3 is a perspective structural diagram of an embodiment of the present disclosure from another perspective;

FIG. 4 is an enlarged view of part B in FIG. 3;

FIG. 5 is a perspective structural diagram of a firing pin according to an embodiment of the present disclosure; and

FIG. 6 is a perspective structural diagram of a transition member according to an embodiment of the present disclosure.

### LIST OF REFERENCE SIGNS IN THE FIGURES OF THE PRESENT DISCLOSURE

pneumatic tool body 1, guide chute 11, firing pin 2, first engaging part 21, second engaging part 22, air storage chamber 3, driving device 4, driving wheel 5, first driving part 51, second driving part 52, extension 53, transition member 6, acting part 61, abutting part 62.

### DETAILED DESCRIPTION OF EMBODIMENTS

The present disclosure will be described in further detail below with reference to the accompanying drawings.

The following description is for purposes of disclosing the present disclosure so that those skilled in the art can implement the present disclosure. The preferred embodiments in the following description are by way of example only, and other obvious variations are conceivable to those skilled in the art. The basic principles of the present disclosure defined in the following description may be used in other embodiments, variations, improvements, equivalents, and other technical solutions that do not depart from the spirit and scope of the present disclosure.

It should be understood by those skilled in the art that orientations or positional relationships indicated by the terms “longitudinal”, “transverse”, “upper”, “lower”, “left”, “right”, “front”, “rear”, “vertical”, “horizontal”, “top”, “bottom”, “inner”, “outer”, etc. are based on the orientation or positional relationship shown in the accompanying drawings and are only for facilitating the simplified description of the present disclosure, rather than indicating or implying that an apparatus or an element referred to must have a particular orientation or be constructed and operated in a particular orientation, and therefore the terms will not be interpreted as limiting the present disclosure.

It can be understood that the term “a” is to be understood as “at least one” or “one or more”, i.e., in an embodiment, the number of elements may be one, and in other embodiments, the number of the elements may be multiple, the term “a” shall not be understood as a limitation on the number.

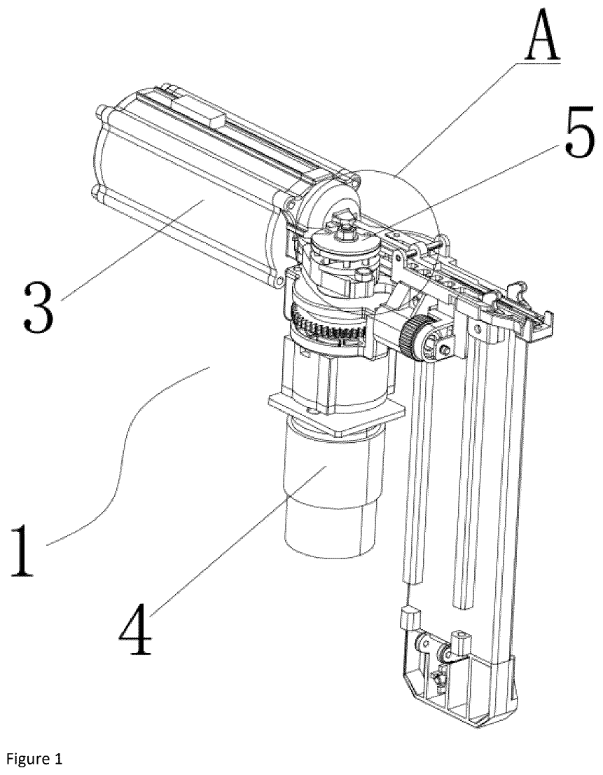

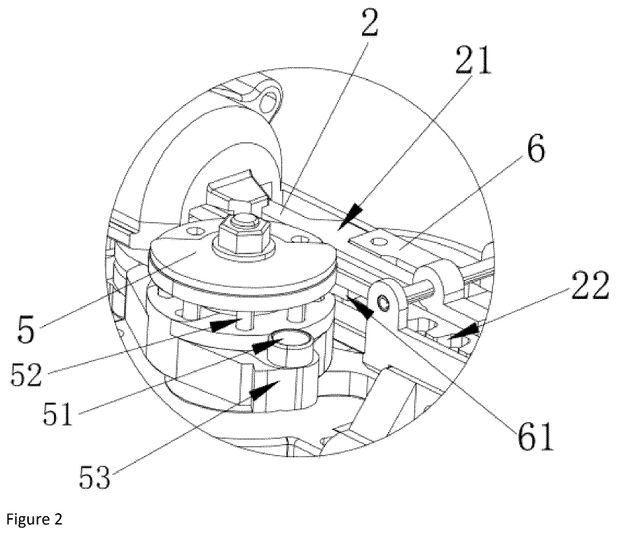

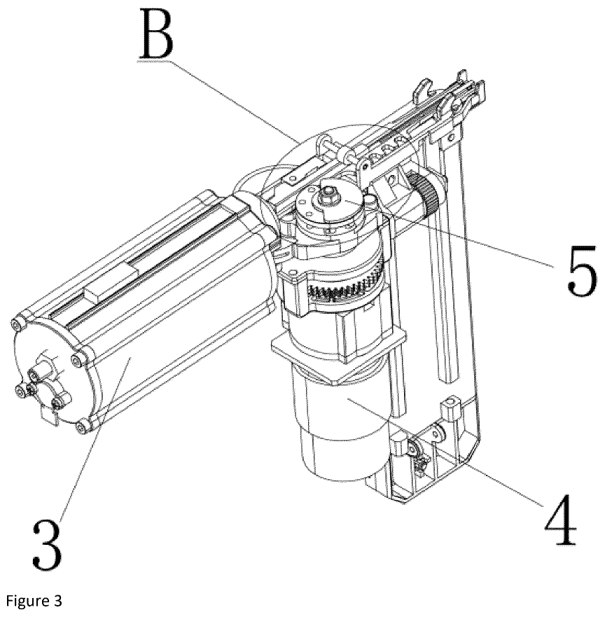

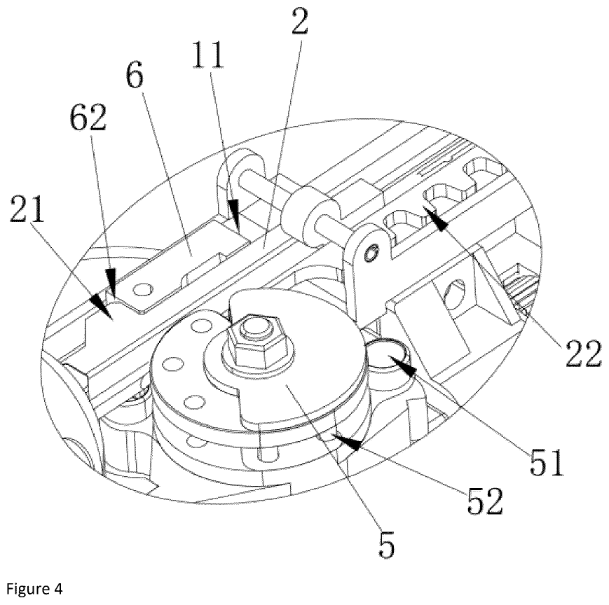

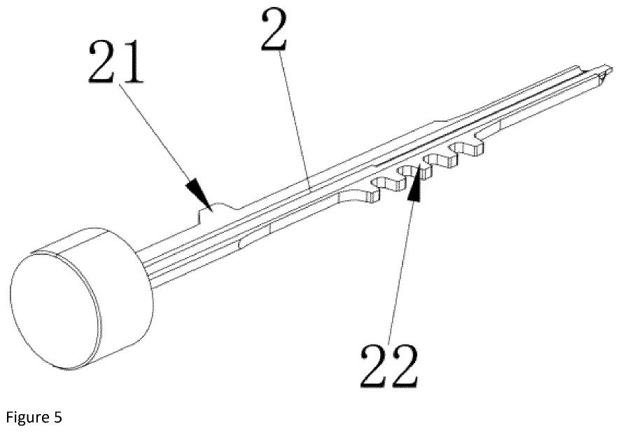

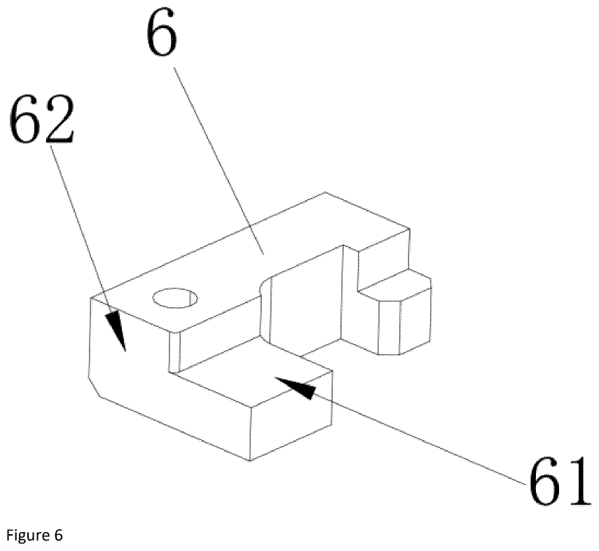

As shown in FIGS. 1 to 6, a firing pin two-stage lifting structure for a pneumatic tool includes a pneumatic tool body 1, a firing pin 2 and a driving mechanism for driving the firing pin to be lifted are disposed in the pneumatic tool body 1, a tail end of the firing pin 2 is fitted in an air storage chamber 3, the driving mechanism includes a driving wheel 5 connected to a driving device 4, the driving wheel 5 is provided with a first driving part 51 and second driving parts 52, a first engaging part 21 and a second engaging part 22 are respectively provided on two sides of the firing pin 2 correspondingly, the first driving part 51 is engaged with the first engaging part 21 via a transition member 6, and the second driving parts 52 are engaged with the second engaging part 22; and as the driving wheel 5 rotates, the first driving part 51 and the second driving parts 52 are sequentially engaged with the first engaging part 21 and the second engaging part 22 correspondingly.

The above driving device 4 is preferably a motor, and a housing (not shown in the figures) is provided outside the pneumatic tool body 1.

The first driving part 51 is a driving block, the first engaging part 21 is a bump disposed on one side of the firing pin 2, and the transition member 6 is disposed across the firing pin 2. The driving block acts on the transition member 6 and then the transition member 6 acts on the bump of the firing pin 2, thereby completing a first-stage lifting.

The transition member 6 is provided with an acting part 61 that extends into a moving trajectory of the first driving part 51, and the transition member 6 is further provided with an abutting part 62 that is in abutting fit with the first engaging part 21.

The second driving parts 52 are a plurality of driving posts spaced apart from each other, the driving posts are distributed in a circular arc, and the second engaging part 22 is a rack disposed on the other side of the firing pin 2. The driving posts act one by one on corresponding teeth of the rack to complete a second-stage lifting.

Since a piston at a rear end of the firing pin 2 compresses air in the air storage chamber 3 during lifting, the internal pressure of the air storage chamber 3 gradually increases as the firing pin 2 is lifted. Therefore, as it increases the distance by which the firing pin is lifted, the force needed for lifting also increases. Herein, a distance from the first driving part 51 to a center of rotation of the driving wheel 5 is greater than a distance from the second driving parts 52 to the center of rotation of the driving wheel 5. That is, a rotation radius of the first driving part 51 is greater than the rotation radius of the second driving parts 52, and in the case of the same motor power, the smaller the rotation radius, the greater the driving force.

The driving wheel 5 is provided with an extension 53 that extends outwards radially, and the first driving part 51 is disposed on the extension 53. With the arrangement of the extension 53, it is possible to expand the space outwards radially to provide a location for arranging the first driving part 51 while the main structure of the driving wheel 5 keeps unchanged.

A guide chute 11 is provided in the pneumatic tool body 1, and the transition member 6 is slidably disposed in the guide chute 11. The arrangement of the guide chute 11 provides a guide for the sliding of the transition member 6 in the pneumatic tool body 1, making it slide more smoothly.

### Operation Principle

According to the firing pin two-stage lifting structure of the present disclosure, the first engaging part 21 and the second engaging part 22 are respectively provided on two sides of the firing pin 2 correspondingly, and the first driving part 51 and the second driving parts 52 are provided on the driving wheel 5; and since the driving wheel 5 is disposed on one side of the firing pin 2, the transition member 6 is provided to enable force transmission between the first driving part 51 and the first engaging part 21 on the opposite side of the firing pin.

When the firing pin 2 is lifted, the driving wheel 5 is driven to rotate by the driving device 4 (motor); and as the driving wheel 5 rotates, the driving block on the driving wheel 5 (i.e., the first driving part 51) acts on the acting part 61 of the transition member 6, and the abutting part 62 of the transition member 6 transmits a force to the bump of the firing pin 2 (i.e., the first engaging part 21), thereby realizing the engagement between the first driving part 51 and the first engaging part 21 to complete a first-stage lifting. After the first-stage lifting, the driving wheel 5 continues to rotate, and the driving posts (i.e., the second driving parts 52) on the driving wheel 5 act one by one on corresponding teeth of the rack of the firing pin 2 to complete a second-stage lifting.

The firing pin two-stage lifting structure of the present disclosure is rational and compact. With the design of the second-stage lifting structure, it increases the distance by which the firing pin 2 is lifted, which can increase a striking force during firing of the firing pin 2.

The description above merely relates to preferred embodiments of the present disclosure, and is not intended to limit the implementations and the scope of protection of the present disclosure. It should be appreciated by those skilled in the art that solutions obtained from equivalent substitutions and obvious variations made using the description and the drawings of the present disclosure shall be included in the scope of protection of the present disclosure.

1. A firing pin two-stage lifting structure for a pneumatic tool, comprising a pneumatic tool body, a firing pin and a driving mechanism for driving the firing pin to be lifted being disposed in the pneumatic tool body, and a tail end of the firing pin being fitted in an air storage chamber, wherein the driving mechanism comprises a driving wheel connected to a driving device, the driving wheel is provided with a first driving part and second driving parts, a first engaging part and a second engaging part are respectively provided on two sides of the firing pin correspondingly, the first driving part is engaged with the first engaging part via a transition member, and the second driving parts are engaged with the second engaging part; and as the driving wheel rotates, the first driving part and the second driving parts are sequentially engaged with the first engaging part and the second engaging part correspondingly.

2. The firing pin two-stage lifting structure for a pneumatic tool according to claim 1, wherein the first driving part is a driving block, the first engaging part is a bump disposed on one side of the firing pin; and the transition member is disposed across the firing pin.

3. The firing pin two-stage lifting structure for a pneumatic tool according to claim 2, wherein the transition member is provided with an acting part that extends into a moving trajectory of the first driving part, and the transition member is further provided with an abutting part that is in abutting fit with the first engaging part

4. The firing pin two-stage lifting structure for a pneumatic tool according to claim 3, wherein the second driving parts are a plurality of driving posts spaced apart from each other, the driving posts are distributed in a circular arc, and the second engaging part is a rack disposed on the other side of the firing pin.

5. The firing pin two-stage lifting structure for a pneumatic tool according to claim 4, wherein a distance from the first driving part to a center of rotation of the driving wheel is greater than a distance from the second driving parts to the center of rotation of the driving wheel.

6. The firing pin two-stage lifting structure for a pneumatic tool according to claim 5, wherein the driving wheel is provided with an extension that extends outwards radially, and the first driving part is disposed on the extension.

7. The firing pin two-stage lifting structure for a pneumatic tool according to claim 6, wherein a guide chute is provided in the pneumatic tool body, and the transition member is slidably disposed in the guide chute.

8. The firing pin two-stage lifting structure for a pneumatic tool according to claim 7, wherein the driving device is a motor.

9. A pneumatic tool, comprising a firing pin two-stage lifting structure for a pneumatic tool according to claim 3.

10. The pneumatic tool according to claim 9, wherein the second driving parts are a plurality of driving posts spaced apart from each other, the driving posts are distributed in a circular arc, and the second engaging part is a rack disposed on the other side of the firing pin.

11. The pneumatic tool according to claim 10, wherein a distance from the first driving part to a center of rotation of the driving wheel is greater than a distance from the second driving parts to the center of rotation of the driving wheel.

12. A method for lifting a firing pin of a pneumatic tool, comprising a firing pin two-stage lifting structure for a pneumatic tool; wherein the firing pin two-stage lifting structure for a pneumatic tool comprises a pneumatic tool body, a firing pin and a driving mechanism for driving the firing pin to be lifted are disposed in the pneumatic tool body, a tail end of the firing pin is fitted in an air storage chamber, the driving mechanism comprises a driving wheel connected to a driving device, the driving wheel is provided with a first driving part and second driving parts, a first engaging part and a second engaging part are respectively provided on two sides of the firing pin correspondingly, the first driving part is engaged with the first engaging part via a transition member, and the second driving parts are engaged with the second engaging part; as the driving wheel rotates, the first driving part and the second driving parts are sequentially engaged with the first engaging part and the second engaging part correspondingly; and the transition member is provided with an acting part that extends into a moving trajectory of the first driving part, and the transition member is further provided with an abutting part that is in abutting fit with the first engaging part;
the method for lifting a firing pin of a pneumatic tool comprising the following steps:
S1: the driving device driving the driving wheel to rotate, the first driving part of the driving wheel acting on the acting part of the transition member, and the abutting part of the transition member transmitting a force to the first engaging part of the firing pin to complete a first-stage lifting of the firing pin; and
S2: the driving wheel continuing to rotate, and the second driving parts acting one by one on the second engaging part of the firing pin to complete a second-stage lifting of the firing pin.

13. The method for lifting a firing pin of a pneumatic tool according to claim 12, wherein the first driving part is a driving block, the first engaging part is a bump disposed on one side of the firing pin, and the transition member is disposed across the firing pin; and the second driving parts are a plurality of driving posts spaced apart from each other, the driving posts are distributed in a circular arc, and the second engaging part is a rack disposed on the other side of the firing pin.

14. The method for lifting a firing pin of a pneumatic tool according to claim 13, wherein a distance from the first driving part to a center of rotation of the driving wheel is greater than a distance from the second driving parts to the center of rotation of the driving wheel.

15. The method for lifting a firing pin of a pneumatic tool according to claim 14, wherein the driving wheel is provided with an extension that extends outwards radially, and the first driving part is disposed on the extension.
